(19) United States
(12) Patent Application Publication
(10) Pub. No.: US 2026/0295642 A1
(43) Pub. Date: Oct. 1, 2026

(54) SENSOR CLEANING DEVICE

(71) Applicants: HYUNDAI MOTOR COMPANY, Seoul (KR); KIA CORPORATION, Seoul (KR); SEOYON E-HWA CO., LTD., Anyang-si (KR)

(72) Inventors: Hyong Do Chung, Hwaseong-si (KR); Won Seop Choi, Hwaseong-si (KR); Sang Hwan Park, Anyang-si (KR)

(73) Assignees: HYUNDAI MOTOR COMPANY, Seoul (KR); KIA CORPORATION, Seoul (KR); SEOYON E-HWA CO., LTD., Anyang-si (KR)

(21) Appl. No.: 19/302,983

(22) Filed: Aug. 18, 2025

(30) Foreign Application Priority Data
Mar. 26, 2025 (KR) 10-2025-0038463

(51) Int. Cl. B08B 7/02; B08B 13/00; B60S 1/56

(52) U.S. Cl. CPC B08B 7/02; B08B 13/00; B60S 1/56

(57) ABSTRACT

A sensor cleaning device includes a housing, a piezoelectric element located in the housing and configured to vibrate, and a cover coupled to the housing and connected to the piezoelectric element. The sensor cleaning device may include at least two piezoelectric elements connected to the cover and configured to vibrate, and a controller configured to apply respective alternating voltages of different frequencies to the at least two piezoelectric elements.

### CROSS-REFERENCE TO RELATED APPLICATION

This application claims under 35 U.S.C. § 119(a) the benefit of priority to Korean Patent Application No. 10-2025-0038463, filed on Mar. 26, 2025, the entire contents of which are incorporated herein by reference.

### BACKGROUND

### (a) Technical Field

The present disclosure relates to a sensor cleaning device.

### (b) Background Art

Sensors are configured to sense a surrounding environment or a physical status of an object. In order to stably maintain sensing performance of sensors, devices or systems including the sensors may include a sensor cleaning device. For example, a vehicle may include sensors configured to assist a driver or enable autonomous driving of the vehicle. The vehicle may include a sensor cleaning device for the sensors.

The sensor cleaning device may clean sensors based on a mechanical method using a wiper or the like, a method of spraying a cleaning liquid or compressed fluid, or a method of applying rotation or vibration to the sensors.

### SUMMARY

The present disclosure has been made in an effort to solve the above-described problems associated with the related art.

The present disclosure is directed to providing a sensor cleaning device that includes a simplified and miniaturized structure and is capable of providing effective cleaning performance.

The present disclosure is directed to providing a sensor cleaning device that may offer advantages in terms of cost or design layout.

Various aspects of the present disclosure are not limited to the above-described aspects. Other aspects that are not mentioned may be more clearly understood by those having ordinary skill in the art to which the present disclosure pertains from the following description.

Features of the disclosed technical concepts to achieve the aspects of the present disclosure described above and perform characteristic functions of the present disclosure described below are as follows.

According to various aspects of the present disclosure, a sensor cleaning device may include: a housing: a piezoelectric element located in the housing and configured to vibrate; and a cover inserted into the housing and connected to the piezoelectric element.

According to various aspects of the present disclosure, a vehicle may include a sensor cleaning device. The sensor cleaning device may include a housing, a piezoelectric element located in the housing and configured to vibrate, and a cover inserted into the housing and connected to the piezoelectric element.

According to various aspects of the present disclosure, a sensor cleaning device may include: a cover; at least two piezoelectric elements connected to the cover and configured to vibrate; and a controller configured to apply alternating voltages of different frequencies to the respective piezoelectric elements.

According to the present disclosure, a sensor cleaning device may be provided. The sensor cleaning device may include a simplified and miniaturized structure and may be capable of providing effective cleaning performance.

According to the present disclosure, a sensor cleaning device may be provided that may offer advantages in terms of cost or design layout.

Effects of the sensor cleaning device of the present disclosure are not limited to the above-described effects. Other effects that are not mentioned should be more clearly understood by those of ordinary skill in the art from the following description.

Other aspects and various embodiments of the disclosure are discussed herein below.

It should be understood that the terms “vehicle” or “vehicular” or other similar terms as used herein are inclusive of motor vehicles in general. Such motor vehicles may encompass passenger automobiles including: sports utility vehicles (SUV), buses, trucks, and various commercial vehicles; watercraft including a variety of boats and ships; aircraft; and the like. Such motor vehicles may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example a vehicle that is both gasoline-powered and electric-powered.

The above and other features of the disclosure are discussed hereinbelow.

### BRIEF DESCRIPTION OF THE DRAWINGS

The above and other features of the present disclosure are described in detail with reference to certain embodiments thereof illustrated the accompanying drawings, which are given hereinbelow by way of illustration only, and thus are not limitative of the present disclosure, and wherein:

FIG. 1 is a conceptual diagram illustrating a sensor cleaning device according to an embodiment of the present disclosure;

FIG. 2 is a perspective view illustrating a sensor cleaning device according to an embodiment of the present disclosure;

FIG. 3 is an exploded perspective view illustrating the sensor cleaning device of FIG. 2;

FIG. 4 is a cross-sectional view taken along line A-A of the sensor cleaning device of FIG. 2;

FIG. 5 illustrates a sensor cleaning device, from which a first housing has been removed, according to an embodiment of the present disclosure;

FIG. 6 illustrates the sensor cleaning device of FIG. 5 from which a piezoelectric element and a pad have been removed;

FIG. 7 illustrates a coupled state of a cover and a piezoelectric element removed from a sensor cleaning device according to an embodiment of the present disclosure;

FIGS. 8-11 illustrate graphs of portions of vibration waveforms generated in a piezoelectric element of a sensor cleaning device according to an embodiment of the present disclosure, in chronological order; and

FIG. 12 illustrates a graph of acceleration according to position on a cover caused by vibration generated in a sensor cleaning device according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Specific structural or functional descriptions presented in embodiments shown and described herein are merely exemplified for the purpose of describing the embodiments according to the concepts of the present disclosure. The embodiments according to the concepts of the present disclosure may be implemented in various forms. In addition, the present disclosure should not be construed as being limited by the embodiments described in the specification. It should be understood that the embodiments of the disclosure include all modifications, equivalents, or substitutes included in the spirit and technical scope of the present disclosure.

In the present disclosure, the terms such as first and/or second may be used to describe various components, but the components are not limited by the terms. The above terms are used only for the purpose of distinguishing one component from another, for example, without departing from the scope of the present disclosure according to the disclosed technical concepts. A first component may be referred to as a second component, and similarly, the second component may also be referred to as the first component.

When a certain component is described as being “connected” or “coupled” to another component, it should be understood that the certain component may be directly connected or coupled to another component or other components may also be disposed therebetween. On the other hand, when a certain component is described as being “directly connected” or “directly coupled” to another component, it should be understood that other components are not disposed therebetween. Other expressions for describing the relationship between components, such as “between” and “directly between” or “adjacent to” and “directly adjacent to” should be construed in the same manner.

The same reference numbers denote the same components throughout the specification. Terms used in the specification are for describing the embodiments and are not intended to limit the present disclosure. In the specification, the singular form also includes the plural form unless specifically stated otherwise. As used herein, terms such as “comprises” and/or “comprising” mean that the stated component, step, operation, and/or element does not preclude the presence of addition of one or more other components, steps, operations, and/or elements. The same applies to other similar terms such as “have,” “include,” and variations thereof.

Hereinafter, the technical concepts and embodiments of the present disclosure are described in detail with reference to the accompanying drawings. When a component, device, unit, module, controller, sensor, element, or the like of the present disclosure is described as having a purpose or performing an operation, function, or the like, the component, device, unit, module, controller, sensor, or element should be considered herein as being “configured to” meet that purpose or to perform that operation or function. The present disclosure describes a controller for a sensor cleaning device. The controller other such components may separately embody or be included with a processor and a memory, such as a non-transitory computer readable media, as part of the controller or component.

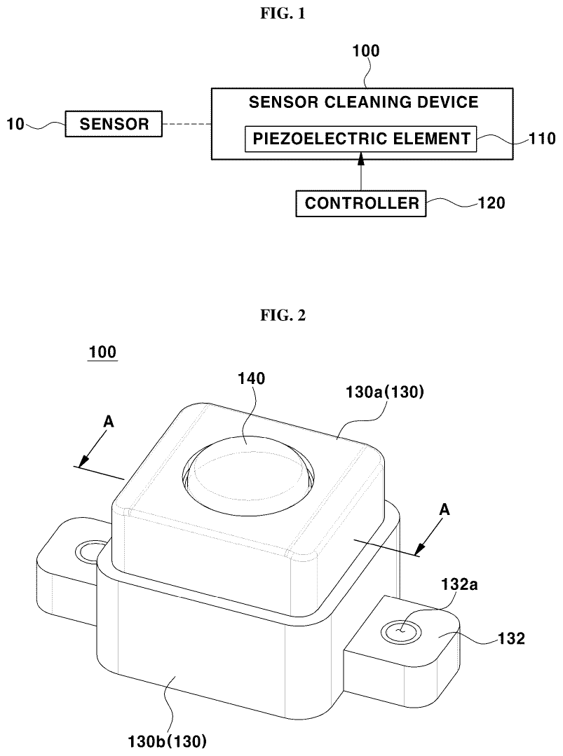

As illustrated in FIG. 1, a sensor cleaning device 100 is configured to perform cleaning of a sensor 10. In an embodiment, the sensor cleaning device 100 may clean the sensor 10 using vibration. For example, the sensor cleaning device 100 may clean the sensor 10 by using vibration caused by ultrasonic waves. The sensor cleaning device 100 may include a piezoelectric element 110 and may clean the sensor 10 through vibration generated by the piezoelectric element 110. The piezoelectric element 110 may generate vibration by application of an alternating voltage. For example, a controller 120 operably connected to the piezoelectric element 110 may be configured to apply an alternating voltage to the piezoelectric element 110 and may adjust the applied alternating voltage.

In an embodiment, the sensor cleaning device 100 may be configured to communicate with the sensor 10. For example, the sensor cleaning device 100 may perform cleaning of the sensor 10, based on determining that the sensor 10 is contaminated. For example, whether the sensor 10 is contaminated may be detected by a known method. Based on determining that the sensor 10 is contaminated, the controller 120 may generate vibration in the piezoelectric element 110. In another embodiment, the sensor cleaning device 100 may clean the sensor 10 independently of communication with or from the sensor 10. For instance, the sensor cleaning device 100 may automatically perform the cleaning of the sensor 10 based on a preset condition. In some examples, the preset condition may be a preset time. The controller 120 may be configured to apply an alternating voltage to the piezoelectric element 110 at a preset time. In some examples, the preset condition may be a request for activating the operation of the sensor cleaning device 100. Based on an input of the request for activating the operation of the sensor cleaning device 100, the controller 120 may apply an alternating voltage to the piezoelectric element 110 to perform the cleaning of the sensor 10. The request for activating the operation of the sensor cleaning device 100 may be generated using an operation button for turning the sensor cleaning device 100 on or off.

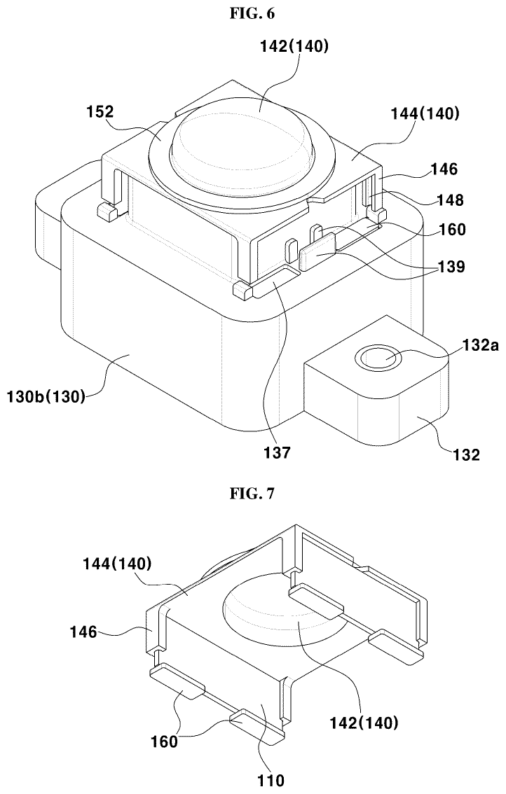

The piezoelectric element 110 is configured to generate vibration. For example, the piezoelectric element 110 may generate vibration by the supply of an alternating voltage. Based on the supply of an alternating voltage to the piezoelectric element 110 by the controller 120, the piezoelectric element 110 may convert the applied electrical energy into mechanical energy and vibrate. Accordingly, foreign substances that are present on a sensing area 12 (see FIG. 4) of the sensor 10 may be removed by the vibration of the piezoelectric element 110.

In an embodiment, the piezoelectric element 110 may include a piezoelectric ceramic. As a non-limiting example, the piezoelectric element 110 may include lead zirconate titanate (PZT), barium titanate, or lead titanate.

Herein, there is no intended limitation on the type of the sensor 10 that can be cleaned by the sensor cleaning device 100. In an embodiment, the sensor 10 may be a sensor configured to sense a presence of an object or a surrounding environment. As a non-limiting example, the sensor 10 may include a light detection and ranging (LiDAR) sensor, a radar sensor, or a camera. In an embodiment, sensors, such as a LiDAR sensor, a radar sensor, or a camera, may be mounted on a vehicle.

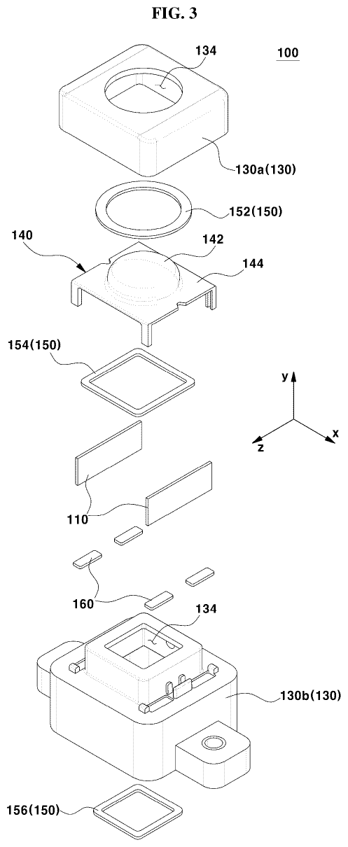

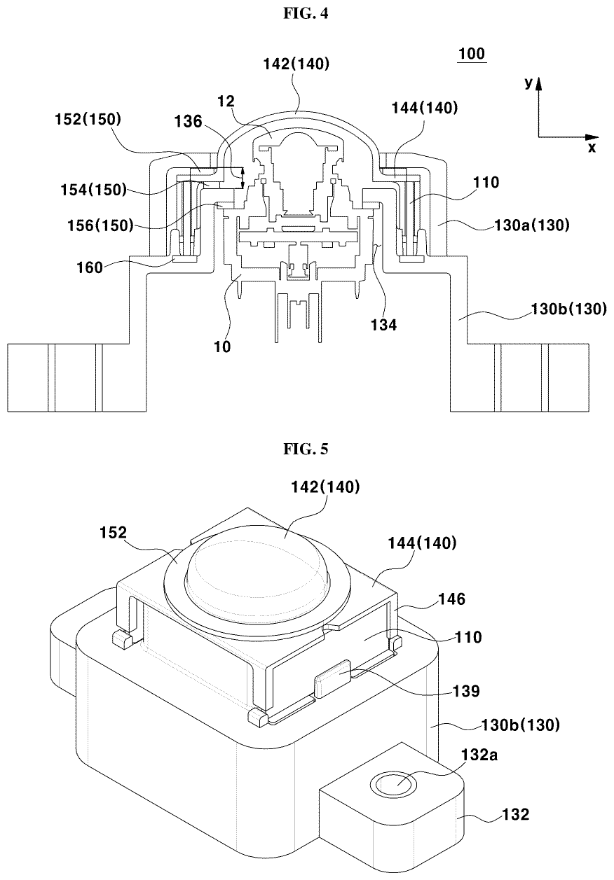

Referring to FIGS. 2-4, in an embodiment, the sensor cleaning device 100 may include a housing 130. The housing 130 may include a bracket 132 that enables the housing 130 to be mounted to a target structure. The bracket 132 may be provided with a coupling hole 132a. A fastener, such as a bolt, may be inserted through the coupling hole 132 to couple the bracket 132 and thus the housing 130 to the target structure to which the housing 130 is mounted so that the housing 130 can be fixed to the target structure.

The housing 130 may accommodate the sensor 10 to enable cleaning of any type of sensor 10. The sensor 10 may be located in the housing 130 and may be removable from the housing 130. In an embodiment, the housing 130 may include a space 134. The sensor 10 may be disposed in the space 134. The sensor 10 may be located in the space 134 and may be removable from the housing 130.

The sensor 10 may be protected by the sensor cleaning device 100. In an embodiment, the sensor cleaning device 100 may include a cover 140. The cover 140 may be disposed to cover the sensor 10 that is located in the space 134. The cover 140 may prevent foreign substances from adhering to the sensor 10 from an external environment. In addition, the cover 140 may be disposed to allow vibration to be applied to the cover 140 by the piezoelectric element 110. In an embodiment, the cover 140 may be disposed to be in direct contact with the piezoelectric element 110.

In an embodiment, the cover 140 may include a main body 142 and a flange 144. The flange 144 may be configured to extend from a periphery of the main body 142. In an embodiment, the main body 142 may have a dome shape, and the flange 144 may extend radially outward from the main body 142. The cover 140 provided with the flange 144 may include a bracket function in addition to serving to protect the sensor 10.

The cover 140 may be supported by the housing 130. In an embodiment, the housing 130 may include a first housing 130a and a second housing 130b, which are separable from each other. A gap 136 (see FIG. 4) may be formed between an upper part of the first housing 130a and the second housing 130b. The cover 140 may be supported within the gap 136 by the upper part of the housing 130. In an embodiment, the flange 144 may be inserted into the gap 136 so that the cover 140 may be supported by the housing 130.

In an embodiment, the cover 140 may be fixed with respect to the housing 130 in the gap 136. For example, a thickness of the flange 144 may correspond to a thickness of the gap 136. Mounting of the cover 140 to the housing 130 may result in the cover 140 being secured to the housing 130, with flange 144 filling the gap 136.

The sensor cleaning device 100 may include a packing element 150. In an embodiment, the cover 140 may be secured to the housing 130 by the packing element 150 or with the packing element 150 disposed within the gap 136. Accordingly, the thickness of the flange 144 may be smaller than the thickness of the gap 136. Furthermore, the packing element 150 is configured to seal the gap 136, i.e., create a seal within the gap 136. According to an embodiment, the packing element 150 may include a first packing 152 and a second packing 154. The first packing 152 may be located between the first housing 130a and the cover 140. The second packing 154 may be located between the cover 140 and the second housing 130b. Specifically, the first packing 152 may be located between the first housing 130a and a first surface of the flange 144, and the second packing 154 may be located between the second housing 130b and a second surface of the flange 144. Accordingly, the gap 136 may be sealed by the packing element 150 and the cover 140 so that foreign substances may be prevented from being introduced into the housing 130 through the gap 136. In some embodiments, the packing element 150 may be integrally formed with the cover 140 or with the flange 144 of the cover 140. In some embodiments, the packing element 150 may be formed separately from the cover 140.

Furthermore, the packing element 150 may include a third packing 156. The third packing 156 may be located between the housing 130 and the sensor 10. For example, the third packing 156 may be located between the second housing 130b and the sensor 10. The third packing 156 may block foreign substances from being introduced toward the sensor 10. As such, the sensor cleaning device 100 may include a a packing element 150, such as one including a plurality of packing elements or multiple packings, such as the first, second, and third packings 152, 154, 156 noted above, to prevent foreign substances from being introduced into the sensor cleaning device 100 and effectively protect the sensor 10.

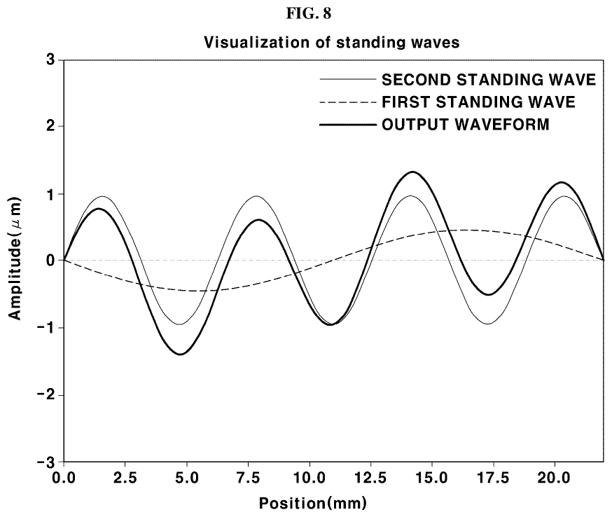

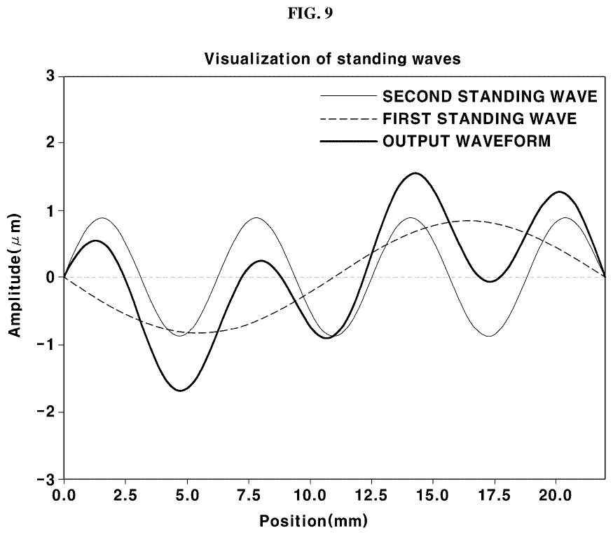

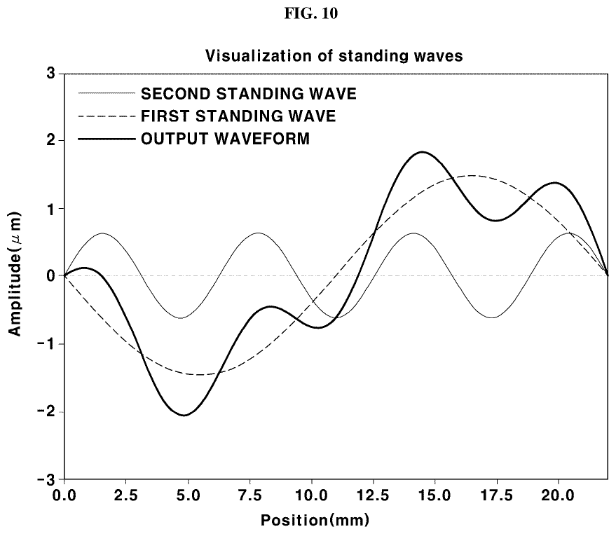

The piezoelectric element 110 may be disposed in the housing 130. For example, the piezoelectric element 110 may be supported by the cover 140 and the housing 130. Additionally, referring to FIGS. 5-7, the piezoelectric element 110 may be coupled to the cover 140 by an interference fit. The cover 140 may include a structure for receiving the piezoelectric element 110 by interference fit. In an embodiment, the cover 140 may include a plurality of legs 146. The legs 146 are configured to vertically extend downward, i.e., extend normal or perpendicular, from the flange 144. The piezoelectric element 110 may be fitted into the legs 146. In an embodiment, a recess 148 may be formed in the legs 146, and the piezoelectric element 110 may be inserted into the recess 148. In addition, the piezoelectric element 110 may be coupled to the second housing 130b. A depressed portion 137 may be formed in the second housing 130b. The piezoelectric element 110 may be coupled to the depressed portion 137 of the second housing 130b through a pad 160. As a non-limiting example, the pad 160 may be an adhesive foam having adhesiveness or an adhesive characteristic or surface. In an embodiment, the second housing 130b may be provided with a protrusion 139 configured to support a side surface of the piezoelectric element 110. As such, a fitting-type structure may be applied to the coupling of the piezoelectric element 110 with the cover 140 and the housing 130, thus providing structural robustness and excellent vibration transmission.

In an embodiment, the piezoelectric element 110 may include multiple elements and each may have a plate shape. Each piezoelectric element 110 may be oriented in the same direction as a direction (Y-axis direction) in which the sensing area 12 of the sensor 10 faces. The piezoelectric element 110 may be configured to vibrate in the Y-axis direction and may transmit vibration to the cover 140. Accordingly, the cover 140 may vibrate in the Y-axis direction in response to an applied frequency band, thus removing contaminants from the main body 142 corresponding to the sensing area 12 of the sensor 10. In other words, the piezoelectric element 110 may be oriented approximately perpendicular to an X-axis direction or longitudinal direction of the cover 140. Vibration of the piezoelectric element 110 in the Y-axis direction or the longitudinal direction may cause the cover 140 to vibrate in the Y-axis direction.

In an embodiment, the sensor cleaning device 100 may include at least two piezoelectric elements 110. The piezoelectric elements 110 may be respectively disposed to face each other at opposite ends or sides of the cover 140. Alternating voltage applied to each of the piezoelectric elements 110 may be independently controlled. In an embodiment, the piezoelectric elements 110 may operate with differences in frequency and phase. Accordingly, the amount of heat generated, and the existence of dead zones may be minimized, and foreign substances attached to the cover 140 may be efficiently removed.

The controller 120 is configured to control the alternating voltage applied to each piezoelectric element 110. In other words, the frequency or phase of the alternating voltage applied to each piezoelectric element 110 may be adjusted. In an embodiment, the piezoelectric elements 110 may be configured to vibrate at different frequencies and have a phase difference from each other.

Vibration generated in the piezoelectric element 110 may create a standing wave in the cover 140. Such a standing wave includes nodes and antinodes, and vibration is not transmitted at the nodes. Accordingly, the present disclosure may cause the two piezoelectric elements 110 to vibrate at different frequencies and to have a phase difference so that node regions becoming dead zones can be minimized and vibration intensity can be amplified. Herein, the dead zone refers to a region where the value in the Y-axis remains fixed at zero.

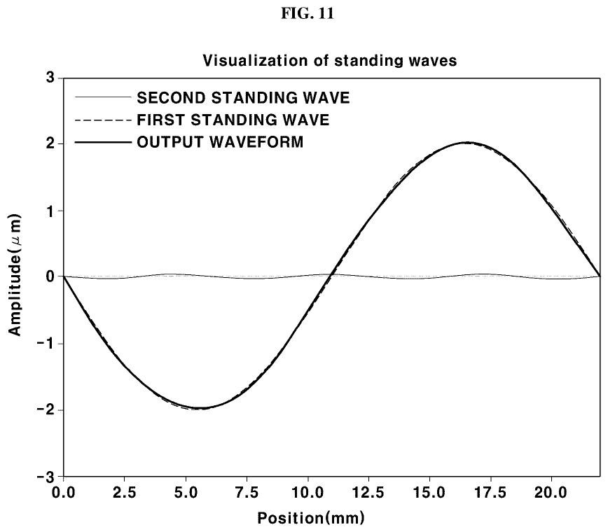

Referring to FIGS. 8-11, according to an embodiment of the present disclosure, the controller 120 may be configured to supply an alternating voltage of a first frequency (e.g., 40 kilohertz to 50 kilohertz) to a first piezoelectric element among the piezoelectric elements 110 and to supply an alternating voltage of a second frequency (e.g., 140 kilohertz to 160 kilohertz) to a second piezoelectric element among the piezoelectric elements. A first standing wave may be generated in the cover 140 by the first frequency, and for example, a single dead zone may be formed excluding the endpoints. In addition, a second standing wave may be generated in the cover 140 by the second frequency, and for example, six dead zones may be formed excluding the endpoints. According to the present disclosure, it can be confirmed that the two standing waves may be combined to enable driving with an output waveform that does not include dead zones (i.e., the output waveform does not include dead zones except at the endpoints). In the illustrated embodiment, the amplitude of vibration reaches a maximum of approximately 2.28 micrometers (μm), confirming that the amplitude is improved by approximately 14% compared to the case where only the first frequency is used for the driving.

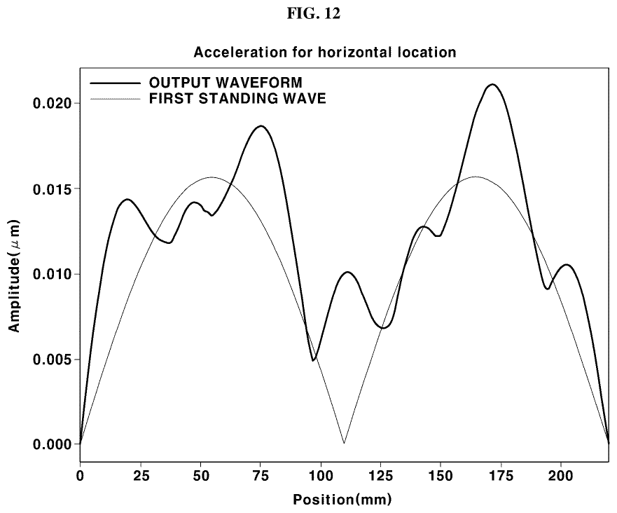

Furthermore, as illustrated in FIG. 12, with reference to the graph showing the acceleration according to the position on the cover 140, acceleration occurs throughout the entire area of the cover 140, which may be more effective in removing contaminants. In other words, the present disclosure may include the two piezoelectric elements 110 located at opposite ends of the sensing area 12 of the sensor 10 and may enable generation of a waveform without a dead zone through detailed tuning of the frequency and phase difference applied to the piezoelectric elements 110.

According to an embodiment of the present disclosure, a sensor cleaning device may be configured to clean an environmental sensor, such as a LiDAR sensor, a radar sensor, or a camera provided in a vehicle.

The present disclosure may provide a sensor cleaning device that includes a simplified and miniaturized structure, compared to cleaning devices based on a fluid injection method.

According to an embodiment of the present disclosure, a sensor cleaning device may be used as a cleaning device for a rear parking camera of a vehicle or the like. Based on being used as a cleaning device for such a single camera, the sensor cleaning device may offer advantages, especially in terms of cost and design layout.

The present disclosure is not limited by the above-described embodiments and the accompanying drawings. It should be apparent to those having ordinary skill in the art to which the present disclosure pertains that various substitutions, modifications, and changes are possible without departing from the scope of the technical spirit of the present disclosure.

What is claimed is:

1. A sensor cleaning device comprising:
a housing:
a piezoelectric element located in the housing and configured to vibrate; and
a cover coupled to the housing and connected to the piezoelectric element.

2. The sensor cleaning device of claim 1, wherein the housing includes a gap and wherein the cover is received in the gap.

3. The sensor cleaning device of claim 2, wherein the housing comprises a first housing and a second housing, wherein the gap is defined between the first housing and the second housing, and wherein a flange of the cover is captured between the first housing and the second housing within the gap.

4. The sensor cleaning device of claim 2, further comprising a packing element configured to create a seal between the housing and the cover at the gap.

5. The sensor cleaning device of claim 1, wherein the housing includes a space, wherein a sensor is received in the space, and wherein a sensing area of the sensor is located adjacent to the cover.

6. The sensor cleaning device of claim 5, further comprising a packing element located between the sensor and the housing.

7. The sensor cleaning device of claim 1, wherein the cover comprises a leg, and wherein the piezoelectric element is coupled to the leg.

8. The sensor cleaning device of claim 7, wherein the leg is provided with a recess into which the piezoelectric element is fitted.

9. The sensor cleaning device of claim 1, wherein the piezoelectric element is attached by a pad to a depressed portion formed in the housing.

10. The sensor cleaning device of claim 1, wherein the housing includes a plurality of protrusions configured to support the piezoelectric element.

11. The sensor cleaning device of claim 1, wherein:
the piezoelectric element comprises at least two piezoelectric elements; and
the piezoelectric elements are configured to receive respective alternating voltages of different frequencies.

12. The sensor cleaning device of claim 11, wherein the alternating voltages respectively applied to the at least two piezoelectric elements have a phase difference.

13. The sensor cleaning device of claim 11, wherein a frequency of an alternating voltage applied to a first piezoelectric element among the at least two piezoelectric elements is greater than a frequency of an alternating voltage applied to a second piezoelectric element among the at least two piezoelectric elements.

14. A vehicle including a sensor cleaning device, wherein the sensor cleaning device comprises:
a housing:
a piezoelectric element located in the housing and configured to vibrate; and
a cover coupled to the housing and connected to the piezoelectric element.

15. The vehicle of claim 14, wherein the sensor cleaning device is configured and arranged to clean a light detection and ranging (LiDAR) sensor, a radar sensor, or a camera disposed in the vehicle.

16. A sensor cleaning device comprising:
a cover;
at least two piezoelectric elements connected to the cover and configured to vibrate; and
a controller configured to apply respective alternating voltages of different frequencies to the at least two piezoelectric elements.

17. The sensor cleaning device of claim 16, wherein the respective alternating voltages applied to the at least two piezoelectric elements have a phase difference.

18. The sensor cleaning device of claim 16, wherein a frequency of a first alternating voltage applied to a first piezoelectric element among the at least two piezoelectric elements is greater than a frequency of a second alternating voltage applied to a second piezoelectric element among the at least two piezoelectric elements.

19. The sensor cleaning device of claim 16, wherein each of the at least two piezoelectric elements is plate shaped.

20. The sensor cleaning device of claim 16, wherein the at least two piezoelectric elements are respectively connected to opposite ends of the cover.
